(19) United States
(12) Patent Application Publication
(10) Pub. No.: US 2026/0287498 A1
(43) Pub. Date: Sep. 24, 2026

(54) SYSTEMS AND METHODS FOR DETERMINING CROSSTALK COEFFICIENTS

(71) Applicant: Roche Sequencing Solutions, Inc., Pleasnanton, CA (US)

(72) Inventor: Ronald Kurnik, Foster City, CA (US)

(21) Appl. No.: 19/676,051

(22) Filed: May 13, 2026

Related U.S. Application Data
(63) Continuation of application No. PCT/EP2024/082085, filed on Nov. 12, 2024.
(60) Provisional application No. 63/598,237, filed on Nov. 13, 2023.

(51) Int. Cl. G01N 21/27; G01N 21/64

(52) U.S. Cl. CPC G01N 21/274; G01N 21/6452; G01N 21/6456; G01N 2201/1211

(57) ABSTRACT

The present disclosure relates to determining crosstalk coefficients for an analyzer based on customer data. In an aspect, a method includes obtaining a manufacturer defined temperature matrix for an analyzer. The method also includes obtaining a customer defined temperature matrix. The method also includes generating a custom temperature dependent crosstalk matrix for a customer. The method further includes performing, based on the custom temperature dependent crosstalk matrix, a matrix inversion and dot matrix multiplication to generate a crosstalk corrected customer fluorescence vector. The method further includes modifying manufacturer defined temperature dependent crosstalk coefficients on the analyzer based on the crosstalk corrected customer fluorescence vector.

### CROSS-REFERENCE TO RELATED APPLICATIONS

The present application is a continuation of International Patent Application No. PCT/EP2024/082085, filed Nov. 12, 2024, which application claims benefit of priority to U.S. Provisional Application No. 63/598,237, filed Nov. 13, 2023, each of which is incorporated by reference herein in its entirety.

### TECHNICAL FIELD

The present disclosure relates to methods for determining crosstalk coefficients, and more particularly, to methods for determining crosstalk coefficients for an analyzer based on customer data.

### BACKGROUND

The polymerase chain reaction (PCR) has become a ubiquitous tool of biomedical research, disease monitoring, and diagnostics. Melting curve analysis has similarly become a common tool used to identify DNA genotypes, often performed after PCR. Melting curve analysis assesses the dissociation characteristics of double strand DNA during heating. In particular, fluorescent dyes bound to double strand DNA typically lose fluorescence as the temperature increases and exhibit a reduction in fluorescence that coincides with the effective dissociation of the DNA. Since different genotypes dissociate at different temperatures, different genotypes thus have melting curves with different profiles. The temperature at which this effective dissociation occurs is often ascertained by identifying peaks formed in the negative first derivative of the melting curve. Thus, negative first derivatives that have similar features (such as the peaks) may indicate curves belonging to the same genotype. Accordingly, analysis of the melting curves (and particularly the negative first derivative thereof) can be used to genotype the assay by grouping together similar curves.

Crosstalk in PCRs is when the fluorescence increase associated with a first dye in a first channel spills over into a second channel used to detect a second dye. Although crosstalk is unavoidable, it can be controlled by calibrating an instrument using crosstalk coefficients. Crosstalk coefficients in melting are temperature dependent and vary with temperature in a non-linear manner over a large temperature range. Currently, PCR analyzers lack the capability for a customer to create their own temperature dependent crosstalk coefficients, and hence the temperature dependent crosstalk coefficients are supplied by a manufacturer of the analyzer at closely measured temperatures over a large temperature range for each channel. The temperature dependent crosstalk coefficients allow for linear interpolation between temperatures for the nonlinear dependence of crosstalk coefficients on temperature. Accordingly, there is a need for an automated method for modifying these crosstalk coefficients based on the needs of a given customer.

### SUMMARY

The present disclosure provides for novel methods for determining crosstalk coefficients for an analyzer based on customer data. In an aspect, a method includes obtaining a manufacturer defined temperature matrix for an analyzer. The method also includes obtaining a customer defined temperature matrix. The method also includes generating a custom temperature dependent crosstalk matrix for a customer. The method further includes performing, based on the custom temperature dependent crosstalk matrix, a matrix inversion and dot matrix multiplication to generate a crosstalk corrected customer fluorescence vector. The method further includes modifying manufacturer defined temperature dependent crosstalk coefficients on the analyzer based on the crosstalk corrected customer fluorescence vector.

In some aspects, the custom temperature dependent crosstalk matrix is based on a manufacturer defined temperature dependent crosstalk matrix, the customer defined temperature matrix, and the manufacturer defined temperature matrix.

In some aspects, the crosstalk corrected customer fluorescence vector is further based on customer defined fluorescent values.

In some aspects, the method further comprises truncating the customer defined temperature values to include temperatures within the manufacturer supplied temperatures.

In some aspects, generating the custom temperature dependent crosstalk matrix comprises interpolating the manufacturer defined temperature dependent crosstalk matrix, the customer defined temperature matrix, and the manufacturer defined temperature matrix.

In some aspects, the interpolating comprises a linear interpolation, a second or third degree cubic spline, or a polynomial interpolation.

In some aspects, the temperatures defined by the manufacturer defined temperature matrix include temperatures between 10 degrees Celsius and 120 degrees Celsius.

In some aspects, the performing the temperature dependent crosstalk correction comprises performing the temperature dependent crosstalk correction for each well of an assay.

In another aspect, a system includes a memory and a processor coupled to the memory. The processor is configured to obtain a manufacturer defined temperature dependent crosstalk matrix for an analyzer. The processor is further configured to obtain a customer defined temperature matrix. The processor is further configured to generate a temperature dependent crosstalk matrix for a customer. The processor is further configured to perform, based on the temperature dependent crosstalk matrix, a matrix inversion and dot matrix multiplication to generate a crosstalk corrected customer fluorescence vector. The processor is further configured to modify the manufacturer defined temperature dependent crosstalk coefficients on the analyzer based on the crosstalk corrected customer fluorescence vector.

### BRIEF DESCRIPTION OF THE DRAWINGS

FIG. 1 is a block diagram illustrating an embodiment an optical system of an analyzer, according to aspects of the present disclosure.

FIG. 2 shows a method for determining crosstalk coefficients based on customer data, according to aspects of the present disclosure.

FIG. 3 is a block diagram of a computing system in accordance with embodiments of the present disclosure.

### DETAILED DESCRIPTION

The crosstalk coefficients in melting are temperature dependent and vary with temperature in a non-linear manner over a large temperature range. Some analyzers do lack the capability for a customer to create their own temperature dependent crosstalk coefficients, hence these are supplied by a manufacturer of the analyzer at closely measured temperatures over the large temperature range for each channel. When the customer temperature and fluorescent values are received, aspects of the present disclosure allow for accurately determining of crosstalk coefficients based on customer data. This can be achieved by performing an interpolation technique, e.g., linearly interpolation, using the manufacturer's temperature and temperature dependent crosstalk coefficients. As should be understood by those of ordinary skill in the art, these coefficients vary non-linearly over temperature, and are determined in a fine grid to allow for linear interpolation over the temperature range. According to some aspects, the processes of the present disclosure use manufacturer predefined fluorescent dye temperature dependent crosstalk coefficients and applies them to customer fluorescent dye values to correct for the overlap of fluorescent signals between channels.

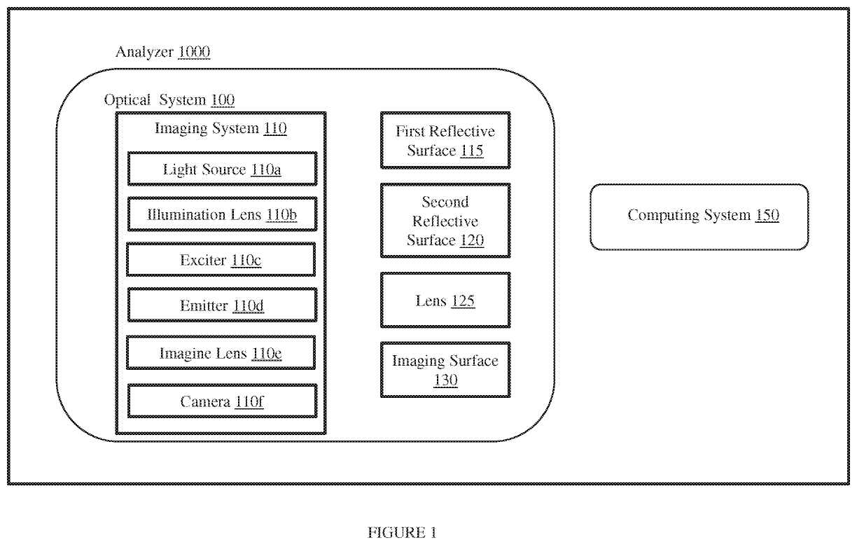

FIG. 1 is a block diagram illustrating an embodiment of an analyzer, according to aspects of the present disclosure. For example, as shown in FIG. 1, an analyzer 1000 includes an optical system 100 and a computing system 150. In some embodiments, the optical system 100 includes an imaging system 110, first and second reflective surfaces 115 and 120, respectively, a lens 125, and an imaging surface 130. In some embodiments, the imaging system 110 may include a light source 110a configured to generate a beam of light, an illumination lens 110b configured to focus the beam of light, and an exciter 110c configured to transmit the focused beam of light onto the first reflective surface 115. In some embodiments, the focused beam of light is reflected off the first reflective surface 115 onto the second reflective surface 120, which in turn is transmitted onto the imaging surface 130 through the lens 125.

In turn, light is reflected from the imagining surface 130 through lens 125 and off of the first and second reflective surfaces 115, 120 onto the imaging system 110. In some embodiments, the imaging system 110 may further include an emitter 110d configured to receive the reflected light from the imaging surface 130, an imaging lens 110e configured to focus the reflected light, and a camera 110f configured to capture the reflected light from the imaging surface 130. In some embodiments, the camera 110f can be used for fluorescence imaging due to its high sensitivity, low noise, and high temporal stability.

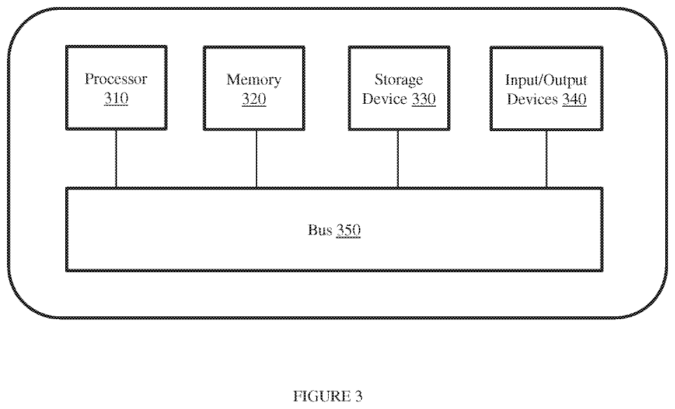

In some embodiments, the computing system 150 may execute one or more processes for determining crosstalk coefficients based on customer data. An example architecture of the computing system 150 is shown in FIG. 3, discussed in greater detail below.

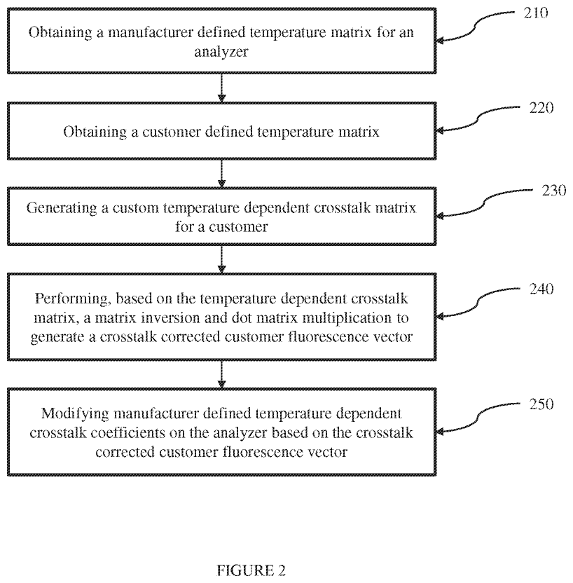

FIG. 2 illustrates a method 200 for determining crosstalk coefficients based on customer data. For example, at step 210, the method 200 may include obtaining a manufacturer defined temperature matrix TMPRfor an analyzer, e.g., analyzer 1000 of FIG. 1. The manufacturer defined temperature matrix TMP_{R} may be stored on a memory, e.g., memory 320 of FIG. 3, and a processor, e.g., processor 310 of FIG. 3, may obtain the manufacturer defined temperature matrix TMP_{R} from the memory. For each well of an assay, a plurality of fluorescent channels, e.g., between two (2) and seven (7) channels, may be used in the analyzer. For purposes of illustration, the present disclosure is described using seven channels, although it should be understood by those of ordinary skill in the art this is merely an example used to demonstrate aspects of the present disclosure. In some instances, each channel may have different temperature vectors, and as such, the manufacturer defined temperature matrix TMP_{R} may be a [N×7] matrix, where N is the number of temperatures determined by the manufacturer. In some embodiments, the temperature may be from 10 degrees Celsius to 120 degrees Celsius.

At 220, the method 200 may include obtaining a customer defined temperature matrix TMP_{C}. For example, the customer defined temperature matrix TMP_{C} may be a [M×7] matrix, where M is the number of temperatures measured by the customer. The customer defined temperature matrix TMP_{C} may be stored on the memory, e.g., memory 320 of FIG. 3, and the processor, e.g., processor 310 of FIG. 3, may obtain the manufacturer defined temperature matrix TMP_{R} from the memory. In some instances, the number of temperatures determined by the manufacturer N may be equal to the number of temperatures measured by the customer M. In other instances, the number of temperatures determined by the manufacturer N may be different than the number of temperatures measured by the customer M. In some embodiments, when the temperatures of the customer defined temperature matrix TMP_{C} are outside the temperatures of the manufacturer defined temperature dependent crosstalk matrix TMP_{R}, these temperatures may be truncated, such that only temperatures within the temperatures of the manufacturer defined temperature dependent crosstalk matrix TMP_{R} are used.

At 230, the method 200 may further include generating a custom temperature dependent crosstalk matrix xtC for a customer. The generating the generating the custom temperature dependent crosstalk matrix xtC may be performed using the processor. In some embodiments, the custom temperature dependent crosstalk matrix xtC may be based on a manufacturer defined temperature dependent crosstalk matrix xtR, the customer defined temperature matrix TMP_{C}, and the manufacturer defined temperature matrix TMP_{R}.

In some embodiments, the manufacturer defined temperature dependent crosstalk matrix xtR may include a plurality of manufacturer defined crosstalk coefficient vectors. In some embodiments, each of the temperatures determined by the manufacturer N a may have a channel specific crosstalk coefficient. At a given temperature N, the, the manufacturer defined temperature dependent crosstalk matrix xtR may be determined as shown in):

$$xTR = ( \begin{matrix}{a}_{11} & … & {a}_{17} \\ ⋮ & ⋱ & ⋮ \\ {a}_{71} & … & {a}_{77}\end{matrix} ) ∈ {ℝ}^{7 x7} \qquad ( 1 )$$

In some embodiments, main diagonal elements of each matrix, i.e., a₁₁, a₂₂, . . . , a₇₇ may be set to 1 for all N temperatures, and each element aᵢⱼ may be defined as the crosstalk coefficient from channel “j” to channel “i”.

The custom temperature dependent crosstalk matrix xtC may be generated by interpolating the manufacturer defined temperature dependent crosstalk matrix xtR, the customer defined temperature matrix TMP_{C}, and the manufacturer defined temperature matrix TMP_{R}. For example, the manufacturer defined temperature dependent crosstalk matrix xtR at temperatures defined by the customer defined temperature matrix TMP_{C} based on the temperatures defined by the manufacturer defined temperature matrix TMP_{R}. In some embodiments, the interpolating may be a linear interpolation, a second or third degree cubic spline, or a polynomial interpolation. In some embodiments, when the temperatures defined by the customer defined temperature matrix TMP_{C} are outside the boundaries of the temperatures defined by the manufacturer defined temperature matrix TMP_{R}, these temperatures may be truncated, such that only temperatures within the temperatures defined by the manufacturer defined temperature matrix TMP_{R} are used. At a given temperature, the custom temperature dependent crosstalk matrix xtC may be determined as shown in equation (2):

$$xtC = ( \begin{matrix}{b}_{11} & … & {b}_{17} \\ ⋮ & ⋱ & ⋮ \\ {b}_{71} & … & {b}_{77}\end{matrix} ) ∈ {ℝ}^{7 x7} \qquad ( 2 )$$

The main diagonal elements, b₁₁, b₂₂, . . . , b₇₇ may be set to 1 for all M temperatures, and each element bᵢⱼ is defined as the crosstalk coefficient from channel “j” to channel “i”.

In some embodiments, when a global user input parameter for “normalization” is set to true, a raw melt curve y may be normalized with respect to its median. When the global user input parameter for “normalization” is set to false, an unchanged raw melt curve is assigned using equation (3):

$${CFV}_{norm} := \{ \begin{matrix}\frac{CFV}{med ( CFV )} , & Normalization = true \\ CFV , & Normalization = false\end{matrix} \qquad ( 1 )$$

In some embodiments, the normalization value CFVₙₒᵣₘ may be used as the raw melt curve in any subsequent processes described herein.

In some embodiments, the linear interpolation may be performed between a plurality of pairs of points. For example, vectors x and y vectors have known data points (x₁, y₁) and (x₂, y₂), and a slope m between x₁, x₂; y₁, y₂ may be determined, as should be understood by those of ordinary skill in the art. Using the slope m, a respective interpolated y-value y_{A} may be determined for each pair of data points, as should be understood by those of ordinary skill in the art.

In some embodiments, the plurality of pairs of points may correspond to the temperatures of the customer defined temperature matrix TMP_{C}. That is, in some embodiments, the interpolated y-value y_{A} may be determined for all points the customer defined temperature matrix TMP_{C}. The interpolated y-values y_{A} may then be used to generate the custom temperature dependent crosstalk matrix xtC.

At 240, the method 200 may further include performing, based on the temperature dependent crosstalk matrix, a matrix inversion and dot matrix multiplication to generate a crosstalk corrected customer fluorescence vector. To achieve this, an initial matrix for the custom temperature dependent crosstalk matrix xtC may be determined. For example, the initial matrix for the custom temperature dependent crosstalk matrix xtC at each temperature may be determined using), where the main diagonal elements, b₁₁, b₂₂, . . . , b₇₇ may be set to 1 for all M temperatures.

$${XT}_{1} = ( \begin{matrix}1 & … & {b}_{17} \\ ⋮ & 1 & ⋮ \\ {b}_{71} & … & 1\end{matrix} ) , {b}_{ij} = 1 if i = j \qquad ( 2 )$$

Furthermore, in some embodiments, performing the matrix inversion may also include defining a column sum vector colSum_{XT1} of the initial matrix for the custom temperature dependent crosstalk matrix xtC using equation (5):

$${colSum}_{{XT}_{1}} = ( sum ( {( {XT}_{1} )}_{* 1} , {( {XT}_{1} )}_{* 2} , … , {( {XT}_{1} )}_{* 7} ) ) \qquad ( 5 )$$

The column sum vector colSum_{XT1} may then be used to determine a final crosstalk matrix XT₂ using equation (6).

$${XT}_{2} = {XT}_{1} / {colSum}_{{XT}_{1}} \qquad ( 6 )$$

In some embodiments, a column sum of column 1 of column sum vector colSum_{XT1}, may be defined using):

$${( {colSum}_{{XT}_{1}} )}_{1} = 1 + {b}_{21} + {b}_{31} + {b}_{41} + {b}_{51} + {b}_{61} + {b}_{71} \qquad ( 7 )$$

Additionally, a first column of XT₂ may be defined using):

$${( {XT}_{2} )}_{* 1} = {( {XT}_{1} )}_{* 1} / {( {colSum}_{{XT}_{1}} )}_{1} . \qquad ( 8 )$$

In some embodiments, the foregoing calculations may be performed for each column of the matrix.

In some embodiments, for a full matrix XT₂, the matrix inversion may be performed using a QR method as shown in equation (9):

$${XT}_{2}^{- 1} = QR inverse [ {XT}_{2} ] . \qquad ( 9 )$$

In some embodiments, the full matrix XT₂ may be a lower triangular matrix, which has as its determinant the product of the main diagonal. As a result, this allows for a simpler inversion formula. The lower triangular matrix may be used for a 5×5 matrix or smaller. As one example, for a 4×4 matrix, the lower triangular matrix may be determined using equation (10):

$${XT}_{1} = ( \begin{matrix}1 & 0 & 0 & 0 \\ {b}_{21} & 1 & 0 & 0 \\ {b}_{31} & {b}_{32} & 1 & 0 \\ {b}_{41} & {b}_{42} & {b}_{43} & 1\end{matrix} ) \qquad ( 10 )$$

With column sums of (colSum_{XT}_{₁})₁, (colSum_{XT}_{₁})₂; (colSum_{XT1})₃, (colSum_{XT}_{₁})₄ the inverse matrix

$${XT}_{2}^{- 1}$$

of the full matrix XT₂ may be calculated using equation (11):

$${XT}_{2}^{- 1} = ( \begin{matrix}{( {S}_{{XT}_{1}} )}_{1} & 0 & 0 & 0 \\ - {{b}_{21} ( {S}_{{XT}_{1}} )}_{2} & {( {S}_{{XT}_{1}} )}_{2} & 0 & 0 \\ - {{b}_{31} ( {S}_{{XT}_{1}} )}_{3} + {b}_{21} {{b}_{32} ( {S}_{{XT}_{1}} )}_{3} & - {{b}_{32} ( {S}_{{XT}_{1}} )}_{3} & {( {S}_{{XT}_{1}} )}_{3} & 0 \\ - {b}_{41} + {b}_{31} {b}_{43} + {b}_{21} ( {b}_{42} - {b}_{32} {b}_{43} ) & - {b}_{42} + {b}_{32} {b}_{43} & - {b}_{43} & 1\end{matrix} ) \qquad ( 2 )$$

In some embodiments, S_{XT}_{₁} may be equal to colSum_{XT}_{₁}.

As another example, for a 5×5 lower triangular matrix, the columns Colᵢ, i∈[1, . . . , 5] of the inverse matrix

$${XT}_{2}^{- 1}$$

may be determined using equations (12)-(16):

$${Col}_{1} = ( \begin{matrix}{( {S}_{{XT}_{1}} )}_{1} \\ - {{b}_{21} ( {S}_{{XT}_{1}} )}_{2} \\ - {{b}_{31} ( {S}_{{XT}_{1}} )}_{3} + {b}_{21} {{b}_{32} ( {S}_{{XT}_{1}} )}_{3} \\ ( - {b}_{41} + {b}_{31} {b}_{43} + b\_ 21 ( {b}_{42} - {b}_{32} {b}_{43} ) {( {S}_{{XT}_{1}} )}_{4} \\ - {b}_{51} + {b}_{31} {n}_{53} + {b}_{41} {b}_{54} - {b}_{31} {b}_{43} {b}_{54} + {b}_{21} ( {b}_{52} - {b}_{32} {b}_{53} - {b}_{42} {b}_{54} + {b}_{32} {b}_{43} {b}_{54} )\end{matrix} ) \qquad ( 12 )$$

$${Col}_{2} = ( \begin{matrix}0 \\ {( {S}_{{XT}_{1}} )}_{2} \\ - {{b}_{32} ( {S}_{{XT}_{1}} )}_{3} \\ - {{b}_{42} ( {S}_{{XT}_{1}} )}_{4} + {b}_{32} {{b}_{43} ( {S}_{{XT}_{1}} )}_{4} \\ - {b}_{52} + {b}_{42} {b}_{54} + {b}_{32} ( {b}_{53} - {b}_{43} {b}_{54} )\end{matrix} ) \qquad ( 13 )$$

$${Col}_{3} = ( \begin{matrix}0 \\ 0 \\ {( {S}_{{XT}_{1}} )}_{3} \\ - {{b}_{43} ( {S}_{{XT}_{1}} )}_{4} \\ - {b}_{53} + {b}_{43} {b}_{54}\end{matrix} ) \qquad ( 14 )$$

$${Col}_{4} = ( \begin{matrix}0 \\ 0 \\ 0 \\ {( {S}_{{XT}_{1}} )}_{4} \\ - {b}_{54}\end{matrix} ) \qquad ( 15 )$$

$${Col}_{5} = ( \begin{matrix}0 \\ 0 \\ 0 \\ 0 \\ 1\end{matrix} ) \qquad ( 16 )$$

In the example, the inverse matrix

$${XT}_{2}^{- 1}$$

may be determined equation (17):

$${XT}_{2}^{- 1} = ( {Col}_{1} , {Col}_{2} , {Col}_{3} , {Col}_{4} , {Col}_{5} ) ∈ {ℝ}^{5 x5} . \qquad ( 17 )$$

In some embodiments, the processes described herein for crosstalk coefficient correction may be applied to user selected channels. That is, a user may select certain channels for the crosstalk coefficient correction to be performed on, and for these channels, crosstalk correction is performed, while the unselected channels remain unchanged and a raw input curve is returned.

In some embodiments, the inverse matrix

$${XT}_{2}^{- 1}$$

is stored on a memory, e.g., memory 320 of FIG. 3, such that it may be used for each well without repeating the calculations. At each temperature M, the inverse matrix

$${XT}_{2}^{- 1}$$

may be applied to customer fluorescent values CFV for each channel in each well as a function of the M temperatures to obtain the crosstalk corrected customer fluorescence vector CFV_{XTC}. For example, the i-th row of the crosstalk corrected customer fluorescence vector CFV_{XTC} may be calculated using equation (18):

$${CFV}_{XTC} = ( \begin{matrix}XT {2}^{- 1} {( CFV )}_{1 *} \\ XT {2}^{- 1} {( CFV )}_{2 *} \\ ⋮ \\ XT {2}^{- 1} {( CFV )}_{k - 1 *} \\ XT {2}^{- 1} {( CFV )}_{k *}\end{matrix} ) ∈ {ℝ}^{kxl} \{ \begin{matrix}k = Number of \\ data points \\ l = Number of \\ channels\end{matrix} \qquad ( 18 )$$

That is, equation (18) illustrates the matrix containing the crosstalk corrected customer fluorescence vector CFV_{XTC}.

At 250, the method 200 may further include modifying manufacturer defined temperature dependent crosstalk coefficients on the analyzer based on the crosstalk corrected customer fluorescence vector CFV_{XTC}. For example, the manufacturer defined temperature dependent crosstalk coefficients may be stored on the memory, e.g., memory 320 of FIG. 3, and the modifying may include overwriting these values with values from the crosstalk corrected customer fluorescence vector CFV_{XTC}. As a result, the analyzer 1000 may be customized at the customer site in accordance with the operating conditions set by the customer.

A person of ordinary skill in the art would appreciate that the processes described herein are computationally complex, and as such, cannot be reasonably performed manually. For example, performing the aforementioned processes manually would be excessively time consuming and would render the analyzer 1000 inoperable while a customer determined the crosstalk corrected customer fluorescence vector CFV_{XTC}. As another example, any miscalculations caused by performing these processes manually may cause the analyzer 1000 to malfunction.

FIG. 3 depicts a block diagram illustrating an example of computing system 300, in accordance with some example embodiments. In some embodiments, the computing system 300 may be to implement the method 200 and/or any components therein.

As shown in FIG. 3, computing system 300 can include a processor 310, a memory 320, a storage device 330, and input/output devices 340. Processor 310, memory 320, storage device 330, and input/output devices 340 can be interconnected via system bus 350. Processor 310 is capable of processing instructions for execution within the computing system 300. Such executed instructions can implement one or more components of, for example, analyzer 1000, method 200 and/or any components therein. In some example embodiments, processor 310 can be a single-threaded processor. Alternately, processor 310 can be a multi-threaded processor. Processor 310 is capable of processing instructions stored in memory 320 and/or on the storage device 330 to display graphical information for a user interface provided via the input/output device 340.

Memory 320 is a computer readable medium such as volatile or non-volatile that stores information within computing system 300. Memory 320 can store data structures representing configuration object databases, for example. Storage device 330 is capable of providing persistent storage for computing system 300. Storage device 330 can be a floppy disk device, a hard disk device, an optical disk device, or a tape device, or other suitable persistent storage means. Input/output device 340 provides input/output operations for the computing system 300. In some example embodiments, input/output device 340 includes a keyboard and/or pointing device. In various implementations, the input/output device 340 includes a display unit for displaying graphical user interfaces.

According to some example embodiments, input/output device 340 can provide input/output operations for a network device. For example, input/output device 340 can include Ethernet ports or other networking ports to communicate with one or more wired and/or wireless networks (e.g., a local area network (LAN), a wide area network (WAN), the Internet).

In some example embodiments, computing system 300 can be used to execute various interactive computer software applications that can be used for organization, analysis and/or storage of data in various formats. Alternatively, computing system 300 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via input/output device 340. The user interface can be generated and presented to a user by computing system 300 (e.g., on a computer screen monitor, etc.).

One or more aspects or features of the subject matter described herein can be realized in digital electronic circuitry, integrated circuitry, specially designed application-specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

Embodiments of the present invention will be further described in the following examples, which do not limit the scope of the invention described in the claims.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method comprising:
obtaining a manufacturer defined temperature matrix for an analyzer;
obtaining a customer defined temperature matrix;
generating a custom temperature dependent crosstalk matrix for a customer;
performing, based on the custom temperature dependent crosstalk matrix, a matrix inversion and dot matrix multiplication to generate a crosstalk corrected customer fluorescence vector; and
modifying manufacturer defined temperature dependent crosstalk coefficients on the analyzer based on the crosstalk corrected customer fluorescence vector.

2. The method of claim 1, wherein the custom temperature dependent crosstalk matrix is based on a manufacturer defined temperature dependent crosstalk matrix, the customer defined temperature matrix, and the manufacturer defined temperature matrix.

3. The method of claim 1, wherein the crosstalk corrected customer fluorescence vector is further based on customer defined fluorescent values.

4. The method of claim 1, further comprising truncating the customer defined temperature values to include temperatures within the manufacturer supplied temperatures.

5. The method of claim 4, wherein generating the custom temperature dependent crosstalk matrix comprises interpolating the manufacturer defined temperature dependent crosstalk matrix, the customer defined temperature matrix, and the manufacturer defined temperature matrix.

6. The method of claim 5, wherein the interpolating comprises a linear interpolation, a second or third degree cubic spline, or a polynomial interpolation.

7. The method of claim 1, wherein temperatures defined by the manufacturer defined temperature matrix include temperatures between 10 degrees Celsius and 120 degrees Celsius.

8. The method of claim 1, wherein performing the temperature dependent crosstalk correction comprises performing the temperature dependent crosstalk correction for each well of an assay.

9. A system comprising:
a memory; and
a processor coupled to the memory and configured to:
obtain a manufacturer defined temperature dependent crosstalk matrix for an analyzer;
obtain a customer defined temperature matrix;
generate a temperature dependent crosstalk matrix for a customer;
perform, based on the temperature dependent crosstalk matrix, a matrix inversion and dot matrix multiplication to generate a crosstalk corrected customer fluorescence vector; and
modify the manufacturer defined temperature dependent crosstalk coefficients on the analyzer based on the crosstalk corrected customer fluorescence vector.
